(19) United States
(12) Patent Application Publication
(10) Pub. No.: US 2014/0023758 A1
(43) Pub. Date: Jan. 23, 2014

(54) METHOD OF AND APPARATUS FOR MANUFACTURING CHOCOLATE PRODUCTS, AND MOULD PLATE ASSEMBLIES

(71) Applicant: John Wesley Taylor, Burleigh Heads (AU)

(72) Inventor: John Wesley Taylor, Burleigh Heads (AU)

(73) Assignee: CHOCOLATE GRAPHICS PTY LTD, Burleigh Heads, Queensland (AU)

(21) Appl. No.: 14/111,413

(22) PCT Filed: Apr. 16, 2012
(86) PCT No.: PCT/AU2012/000391

§ 371 Date: Oct. 11, 2013

(30) Foreign Application Priority Data
Apr. 14, 2011 (AU) 2011901415

(51) Int. Cl. A23G 1/22; A23G 1/00

(52) U.S. Cl. CPC A23G 1/22; A23G 1/005
USPC 426/249; 425/588; 249/160; 425/150

(57) ABSTRACT

A method of and apparatus for, the manufacture of chocolate products formed from chocolate of at least two colours, where mould assemblies arranged with mould cavities in columns and rows are advanced under a filling head which fills the mould cavities in a row, advances the mould assemblies and vibrates the mould assemblies to release any air trapped in the mould cavities. The mould cavities are provided in mould plates formed from acrylic sheet material, enabling chocolates of a wide range of shapes/sizes to be manufactured, where the chocolates may have sharp edges for added aesthetic appeal.

### BACKGROUND OF THE INVENTION

1. Field of the Invention

THIS INVENTION relates to a method of, and apparatus for, manufacturing chocolate products, including the moulds therefore.

The invention is particularly suitable for, but not limited to, a method of and apparatus for the production of chocolate products having thin raised design(s) thereon in different colour(s) than the rest of the chocolate products; and to the chocolate products produced by such a method and apparatus.

International Publications WO 97/39636 (=PCT/AU97/00245) and WO 02/15707 (=PCT/AU01/01067) disclosed respective methods for the manufacture of chocolate products with thin raised design(s) with at least one different colour chocolate thereon.

International Publication WO 2005/029971 (=PCT/AU2004/001330) disclosed a method of manufacturing mould plates for the respective manufacturing methods, where the cavities in the second mould plate each register with the engraved designs in the graphic plates.

The method disclosed in International Publication WO 02/15707 was designed for higher-output production, or at least semi-commercial production, of the chocolates.

While the manufacturing method disclosed in International Publication WO97/39636 has proved successful internationally, the method is suitable for at least small-scale commercial production of the chocolates; and only a limited range of chocolate shapes could be produced. Furthermore, the scraping of the excess chocolate from the mould cavities can adversely affect the appearance of the underside of the chocolates.

The present invention is designed to build on the strong base of that manufacturing method by introducing improvements thereto.

### SUMMARY OF THE PRESENT INVENTION

It is an object of the present invention to provide a method of, and/or apparatus for, higher production rates of the chocolate products having a raised design thereon in at least one colour of chocolate.

It is a preferred object of the present invention to provide moulds for the production of chocolates which can be of any size and/or shape, while enabling the production of a larger number of chocolates per mould sheet.

It is a further preferred object of the present invention to provide shape moulds for the manufacture of chocolates, where the chocolates can be manufactured with sharp edges for improved aesthetic appeal.

It is a still further preferred object to provide a method where three-dimensional (3-D) designs can be produced on the chocolates.

It is a still further preferred object to enable photographic-like images to be produced on the chocolates.

Other preferred objects of the present invention will become apparent from the following description.

In one aspect, the present invention resides in a method of producing chocolate including:

a) placing a shape mould , having a plurality of mould cavities (optionally arranged in columns and rows), each shape mould cavity being in register with a pattern for a first chocolate colour, on a table of a filling machine;
b) advancing the shape mould along the table so that at least one row of the mould cavities is located below respective injectors of the filling head;
c) filling each shape mould cavity in the row with a preselected volume of chocolate of a second colour supplied in at least semi-liquid form from a chocolate supply;
d) applying vibration to the shape mould during, and/or immediately after, the filling step; and
e) removing the shape “mould when the chocolate of the second colour has at least partially set.

Preferably, steps b), c) and d) are repeated until all the rows of the mould cavities have been filled.

In a second aspect, the present invention resides in an apparatus for the manufacture of chocolate including:

a table adapted to receive and guide “shape moulds” of the type having a plurality of shape mould cavities (optionally arranged in columns and rows), each of the shape mould cavities being in register with a pattern for a chocolate of a first colour;
a filling head spaced above the table and having respective injectors to feed chocolate of a second colour to at least one row of shape mould cavities;
a chocolate supply operable to maintain the chocolate of the second colour in at least semi-liquid form;
pump means operable to pump the chocolate of the second colour from the chocolate supply to the filling head; and
a vibration generator, operably connected to the table, or a portion of the table, and operable to vibrate the shape moulds during, and/or after, each injection of chocolate of the second colour into the row of shape mould cavities.

Preferably, the table is of a length sufficient to support a plurality of the shape moulds where a first portion is arranged to receive the “shape moulds to be fed under the filling head; a second portion underlies the injectors of the filling head; and a third portion supports the shape moulds downstream of the filling head as the chocolate of the second colour at least partially sets, before the shape moulds are loaded to a cooler.

The vibration generator may be operably connected to the second portion of the table, or to an intermediate portion between the second and third portions of the table where the shape moulds are partially supported by the second and intermediate portions, to enable the mould assemblies to be vibrated, as or after the chocolate of the second colour is injected into the shape mould cavities.

Sensors, such as optical sensors or proximity sensors, may selectively control the advance of the shape moulds under the filling head and/or the operation of the filling head so that the filling head can only operate when the shape mould cavities are accurately aligned with their respective injectors.

While silicon rubber may be used for the manufacture of the moulds (with the mould cavities) overlying the “graphic plate moulds” having the patterns for the chocolate of the first colour; it is preferred that the shape moulds are manufactured from acrylic material, as this material enables the shape moulds” to be configured to produce sharp edges on the resultant chocolates for improved aesthetic appearance or when preferred by the customers.

In addition, the acrylic material enables the shape mould cavities to be machined to any size and/or shape.

The shape mould cavities in the shape moulds may be machined to any desired profile by numerically-controlled cutters or lasers; and the mechanical strength of the acrylic material allows minimal spacing between adjacent shape mould cavities, to enable the maximum number of cavities to be cut from a given size of acrylic sheet than for silicone rubber sheets. In addition, the acrylic shape moulds may be made from acrylic sheets with dimensions of eg. 600 mm×400 mm, or larger, rather than the 400 mm×400 mm maximum dimension for silicone rubbers, to increase production rates.

Alternatively, the shape mould cavities and the patterns for the first colour chocolate may be machined or otherwise formed from a single sheet of acrylic.

The patterns for the first colour chocolate, provided in the graphic plate moulds, may be cut by lasers or other numerically- controlled or computer-controlled cutting or etching machines, so that the designs to be represented can be accurately produced; and it is even possible to produce 3-D designs, or the “shading” of photographs (by reducing/increasing the thickness of the chocolate of the first colour).

In a third aspect, the present invention resides in a shape mould for the manufacture of chocolate including:

a sheet of acrylic plastic; and
at least one shape mould cavity formed in the sheet to receive liquid chocolate of a second colour,
the, or each, shape mould cavity being aligned with at least one pattern for chocolate of a first colour.

The, or each, pattern may be provided on a graphic plate mould, on which the sheet is overlaid; or in a lower surface of the, or each, shape mould cavity.

### BRIEF DESCRIPTION OF THE DRAWINGS

To enable the invention to be fully understood, preferred embodiments will now be described with reference to the accompanying drawings, in which:

FIG. 1 is a top plan view illustrating two mould plate assemblies (which has a shape mould plate placed over a graphic plate mould sheet) placed on the table, and being advanced to, and under, the filling head;

FIGS. 2 and 3 are respective perspective views corresponding to FIG. 1 (where the cover for the vat of the chocolate supply has been removed);

FIGS. 4 and 5 are respective side elevational views of the machine from opposite sides;

FIGS. 6 and 7 are respective end elevational views of the machine from opposite ends;

FIG. 8 is an example of a “3-D” design of a tiger's head;

FIG. 9 shows examples of photographic-like effects, logos and other “3-D” designs which can be produced on chocolates having a range of shapes;

FIG. 10 is a perspective view of a shape mould plate and a graphic plate mould of a mould assembly;

FIG. 11 is a sectional side view of a chocolate product being produced in the mould assembly of FIG. 10; and

FIG. 12 is a similar view of a chocolate product produced in an alternative shape mould plate.

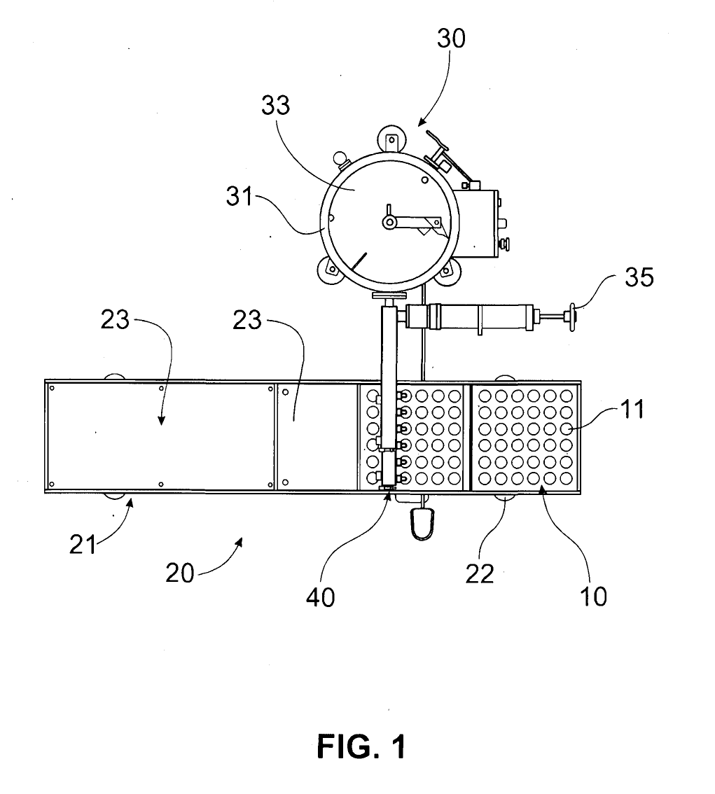

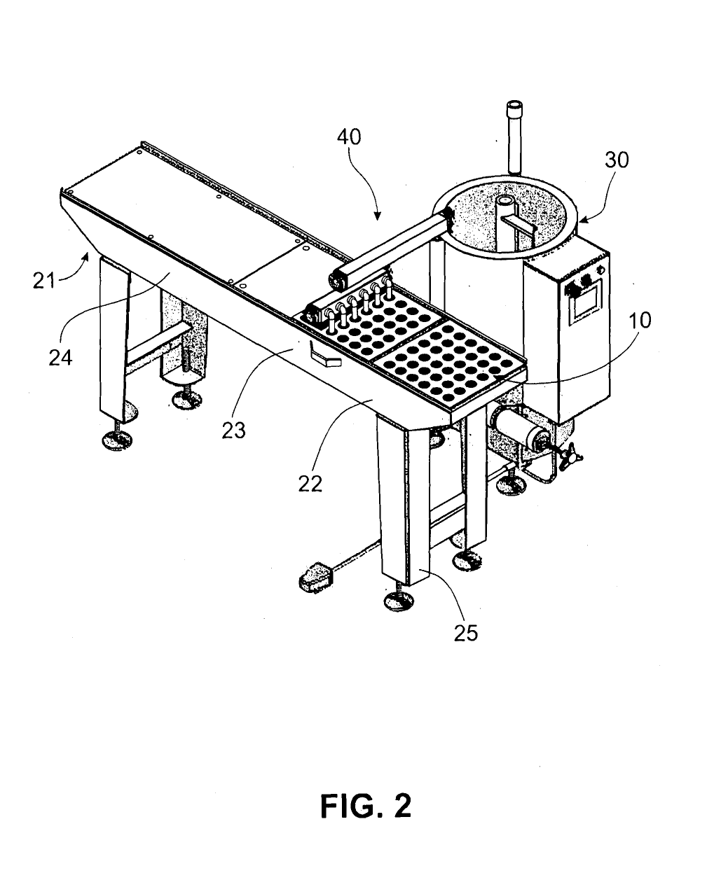

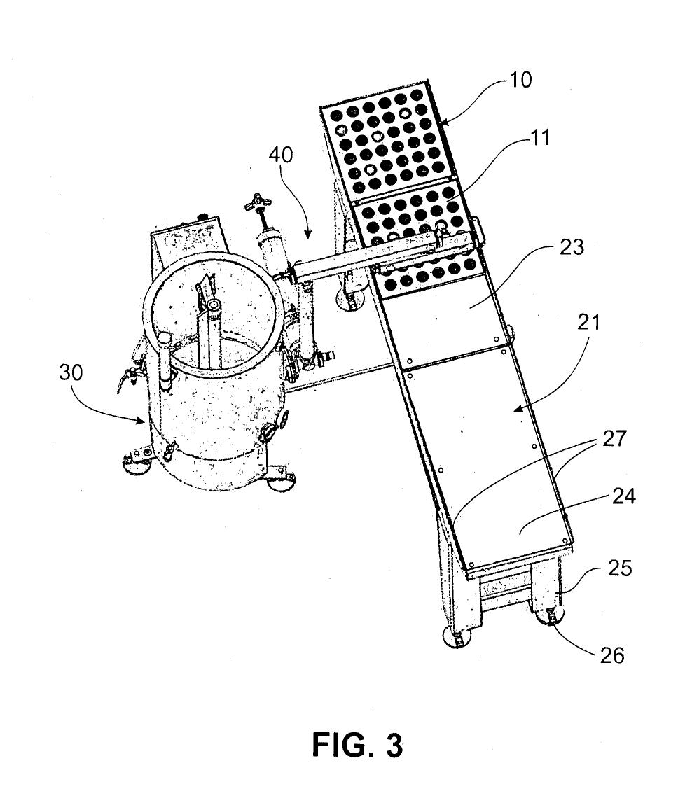

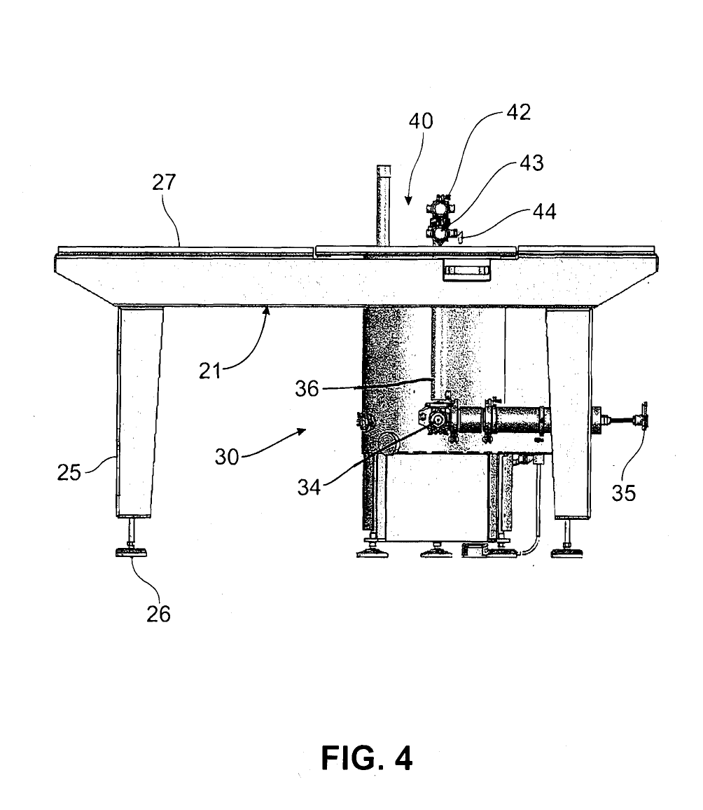

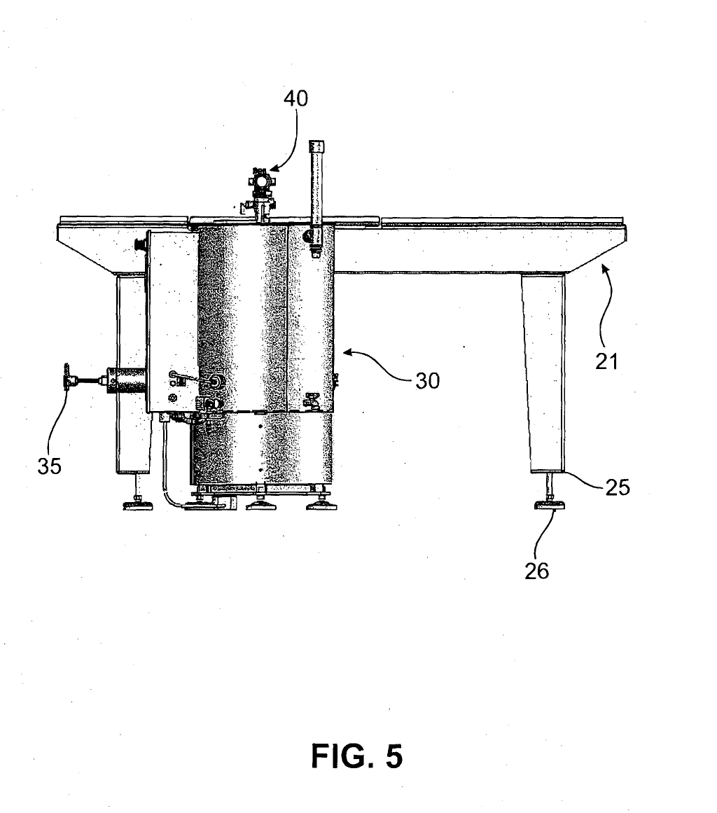

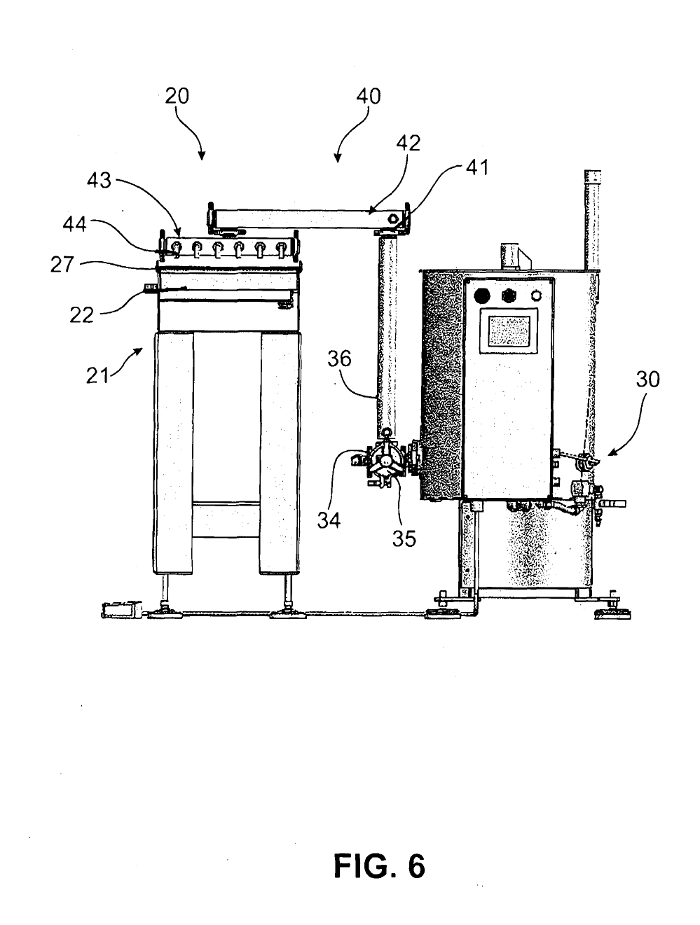

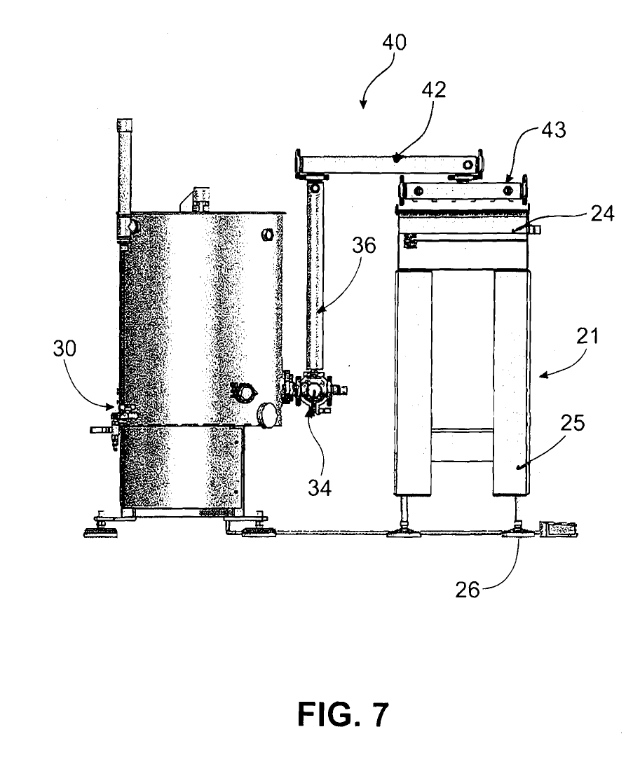

### DETAILED DESCRIPTION OF THE DRAWINGS

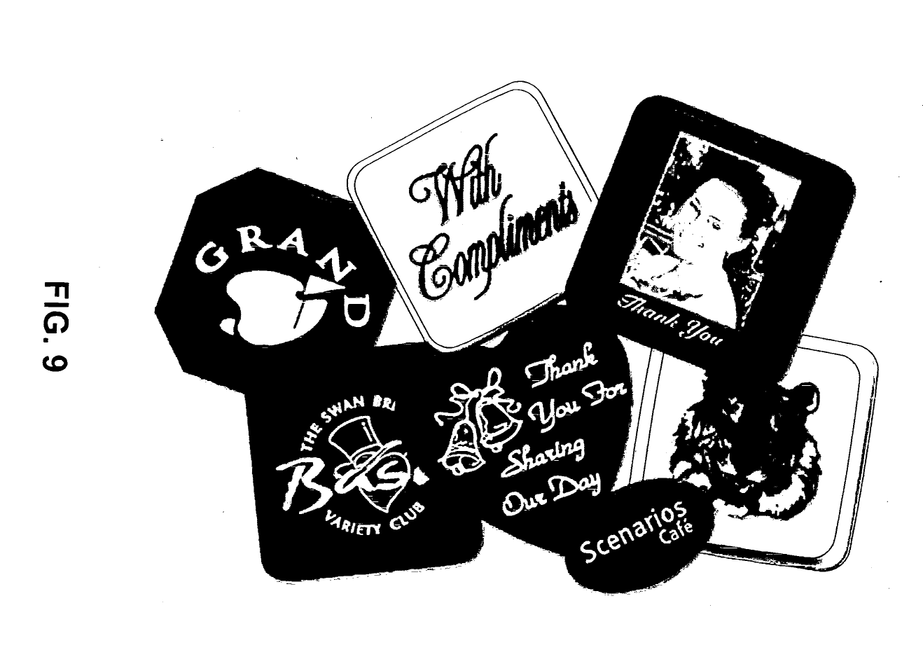

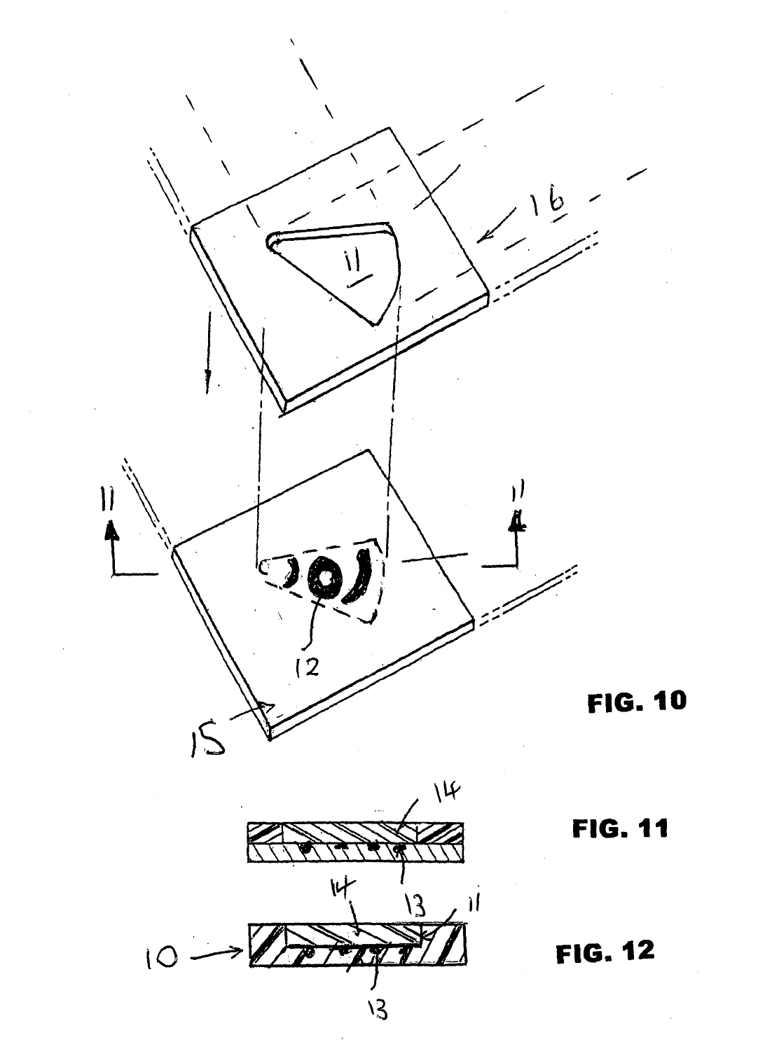

Referring to FIG. 12, each shape mould assembly 10 is formed from acrylic sheet and has respective shape mould cavities 11 arranged in columns and rows, each mould cavity 11 being in register with a respective pattern 12 to be filled with chocolate of a first colour 13, eg., white, to produce a raised pattern on a chocolate of the second colour 14 (e.g., milk chocolate or dark chocolate). The patterns 12 are engraved therein, e.g. by a computer-controlled laser engraver. (In an alternative embodiment shown in FIGS. 10 and 11, the graphic plate mould 15 and second shape mould plate 16 may be machined from respective sheets of acrylic material.)

The machine 20 has a table 21 with a horizontal work surface divided into three portions, with a first portion 22 at a loading end, a second portion 23 under, and adjacent, the filling head 40 (to be hereinafter described), and a third portion 24 for at least partial setting of the second chocolate and discharge.

The table 21 is supported on four legs 25 adjacent its corners, and each leg 25 is provided with an adjustable foot 26 to ensure that the work surfaces of the table 21 can be accurately adjusted to the horizontal.

Side plates 27 extend along each side of the table 21 and operate to. guide the mould assemblies 10 as they are advanced along the table 21.

The chocolate of the second colour 14 is stored within a vat 30, which has a circular side wall 31 and a discharge outlet 32 adjacent the bottom wall. The vat 30 is selectively closed by a removable cover 33; and the chocolate of the second colour 14 within the vat 30 is kept at a strictly controlled temperature range by a heater (not shown) and is continuously stirred by a stirring arm.

The discharge outlet 32 from the vat 30 is connected to an electric, pump 34, the output of which is controlled by a manually operated control wheel 35 adjacent the loading end of the table 21.

A pipe 36 interconnects the output of the pump 34 to the inlet 41 of the filling head 40, which has an arm 42 extending transversely to the table 21, and a manifold 43 suspended therefrom, the manifold 43 having respective injectors 44, where each injector 44 is (preferably) aligned with the centre of a respective mould cavity 11 in a row in the mould assembly 10. (By this arrangement, the second colour chocolate 14 forces the air out of the shape mould cavity 11 as it fills the shape mould cavity 11.)

Each injector 44 has a valve member which precisely dispenses a preset volume of chocolate of the second colour 14 into its respective shape mould cavity 11.

A vibration generator 29 is mounted under the table 21, and is operably connected to the second portion 23 of the table 21 and is computer-controlled to operate for a short period, e.g., 1-2 seconds to vibrate the mould assembly 10 after the chocolate of the second colour 14 has been dispensed into a row of the shape mould cavities 11. When the vibration step has been finished, the mould assembly 10 is advanced to enable the next row of the shape mould cavities 11 therein to be filled, and the mould assembly 10 is again vibrated. This advance/dispensing/vibrating cycle is repeated until all the shape mould cavities 11 in the mould assembly 10 have been filled and the operation is repeated by the next mould assembly 10 , the advance of which has been advancing the preceding mould assembly 10 past the filling head 40.

The second portion 23 of the table 21, or the side plates 27, may have retractable fingers to limit the advance of the mould assembly 10 precisely past the filling head 40.

The vibration of the mould assembly 10 ensures that the chocolate of the second colour 14 will accurately fill the shape mould cavities 11, including any sharp corners, and that no air will be trapped in the shape mould cavities 11 or within the chocolate 14 before it sets. The air must be displaced from the chocolate 14 before a “skin” forms on the chocolate 14 to prevent the release of the air. It is, therefor, preferable that the vibration step is commenced before the dispensing step has been completed.

The mould assembly 10, with the now-filled shape mould cavities 11, is advanced along the third portion 24 of the table 21 until the chocolate of the second colour 14 has at least set to a degree that the chocolates are physically stable. The mould assemblies 10 are removed from the discharge end of the table 21 and loaded into a cooler. When the chocolate 14 has been fully cooled and set, the chocolates can be removed from the mould assemblies 10 for packaging.

It will be readily apparent to the skilled addressee that the manufacture of the mould assemblies 10 from the acrylic sheets, where the shape mould cavities 11, can be accurately machined therefrom by numerically-controlled equipment, will enable the maximum number of shape mould cavities 11 to be produced within a mould assembly of particular dimensions, eg., 400 mm×400 mm or 600 mm×400 mm; while the production of the patterns 12 for the first colour chocolate 13, by laser engraving, enables extremely high quality patterns to be produced, with “shading” by selective “thinning” of the thickness of the first colour chocolate 13.

The shape mould plates 16 produced from acrylic sheet reduce the seepage which can occur with silicone shape mould rubber sheets; and much sharper corners are possible on the chocolates.

The physical strength of the acrylic material allows reduced spacing's between adjacent shape mould cavities 11, together with the ability to produce shape mould cavities 11 of an almost infinite range of sizes and/or shapes. For example, a chocolate “butterfly” would not be possible with conventional shape mould plate materials.

In addition, the use of the machine 20, with the filling head 40, and the vibrating of at least one portion of the table 21, enables a much higher production rate than is possible where the second colour chocolate 14 is placed in the shape mould cavities 11 by hand and any excess chocolate is scraped therefrom. In addition, the volume of chocolate 14 injected into the shape mould cavities 11 can be more accurately controlled and the resultant underside surfaces of the chocolates have an improved appearance.

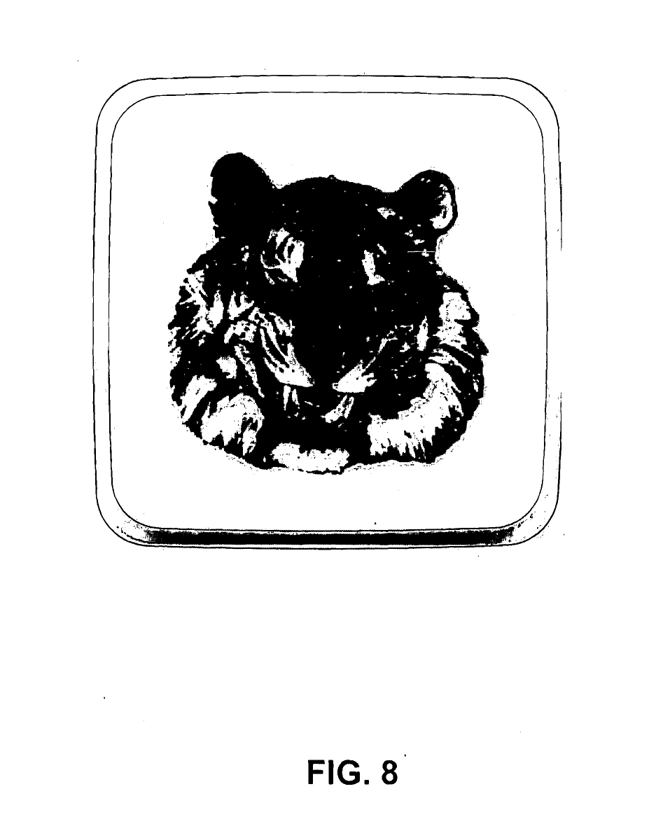

FIG. 8 illustrates an example of a chocolate possible with the present invention, where the depiction of a tiger's head (in darker chocolate), on a substantially-rectangular white chocolate base, is effected in 3-D by thinning/thickening the darker chocolate.

FIG. 9 illustrates further examples possible with the present invention.

The skilled addressee will note that the chocolate-bases can have a range of sizes and/or shapes, including hearts, ellipses and octagons; where the designs thereon can include photographic-like effects, raised lines / letters and/or logos. This demonstrates the designs can be extremely thin, or thick enough, to produce almost any possible design with a very high resolution.

Various changes and modifications may be made to the embodiments described and illustrated without departing from the present invention.

1. A method of producing chocolate including:
a) placing a shape mould having a plurality of shape mould cavities (optionally arranged in columns and rows), each shape mould cavity being in register with a pattern for a first chocolate colour, on a table of a filling machine;
b) advancing the shape mould along the table so that at least one row of the shape mould cavities is located below respective injectors of the filling head;
c) filling each shape mould cavity in the row with a preselected volume of chocolate of a second colour supplied in at least semi-liquid form from a chocolate supply;
applying vibration to the shape mould during, and/or immediately after, the filling step; and
d) removing the shape mould when the chocolate of the second colour has at least partially set.

2. The method of claim 1, wherein:
steps b), c) and d) are repeated until all the rows of the shape mould cavities have been filled.

3. An apparatus for the manufacture of chocolate including:
a table adapted to receive and guide shape moulds of the type having a plurality of shape mould cavities (optionally arranged in columns and rows), each of the shape mould cavities being in register with a pattern for a chocolate of a first colour;
a filling head spaced above the table and having respective injectors to feed chocolate of a second colour to at least one row of shape mould cavities; a chocolate supply operable to maintain the chocolate of the second colour in at least semi-liquid form;
pump means operable to pump the chocolate of the second colour from the chocolate supply to the filling head; and
a vibration generator, operably connected to the table, or a portion of the table, and operable to vibrate the shape moulds during, and/or after, each injection of chocolate of the second colour into the row of shape mould cavities.

4. The apparatus of claim 3, wherein:
the table is of a length sufficient to support a plurality of the shape moulds, wherein:
a first portion is arranged to receive the shape moulds to be fed under the filling head;
a second portion underlies the injectors of the filling head; and a third portion supports the shape moulds downstream of the filling head as the chocolate of the second colour at least partially sets, before the shape moulds are loaded to a cooler.

5. The apparatus of claim 4, wherein:
the vibration generator is operably connected to the second portion of the table, or to an intermediate portion between the second and third portions of the table where the shape moulds are partially supported by the second and intermediate portions, to enable the shape “moulds” to be vibrated, as or after the chocolate of the second colour is injected into the shape mould cavities.

6. The apparatus of claim 3, wherein:
at least one sensor, including optical sensors or proximity sensors, selectively control the advance of the shape moulds under the filling head and/or the operation of the filling head so that the filling head can only operate when the shape mould cavities are accurately aligned with their respective injectors.

7. A shape mould plate for the manufacture of chocolate including:
a sheet of acrylic plastic; and
at least one shape mould cavity formed in the sheet to receive liquid chocolate of a second colour,
the, or each, shape mould cavity being aligned with at least one pattern for chocolate of a first colour.

8. The shape mould plate of claim 7, wherein:
the, or each, pattern is provided on a graphic plate, on which the sheet is overlaid; or in a lower surface of the, or each, mould cavity.

9. The shape mould plate of claim 7,
wherein:
the mould cavities are configured to produce sharp edges on the resultant chocolates for improved aesthetic appearance or when preferred by the customers;
the mould cavities being machined to a profile of any size and/or shape.

10. The shape mould plate of claim 9, wherein:
the mould cavities are machined to the profile by numerically-controlled cutters or lasers;
the mechanical strength of the acrylic material allowing minimal spacing between adjacent mould cavities, to enable the maximum number of cavities to be cut from a given size of acrylic sheet.

11. The shape mould plate of claim 10, wherein:
the acrylic mould plates are made from an acrylic sheet with dimensions of 600 mm×400 mm, or larger, to increase production rates.

12. The shape mould plate of claim 11, wherein:
the mould cavities and the patterns for the first colour chocolate are machined or otherwise formed from a single sheet of acrylic.

13. The shape mould plate of claim 10, wherein:
the patterns for the first colour chocolate, provided in the graphic plate, are cut by lasers or other numerically- controlled or computer-controlled cutting or etching machines, so that the designs to be represented can be accurately produced; and the designs include 3-D designs, or the “shading” of photographs by reducing/increasing the thickness of the chocolate of the first colour.

14. The apparatus of claim 4, wherein:
at least one sensor, including optical sensors or proximity sensors, selectively control the advance of the shape moulds under the filling head and/or the operation of the filling head so that the filling head can only operate when the shape mould cavities are accurately aligned with their respective injectors.

15. The apparatus of claim 5, wherein:
at least one sensor, including optical sensors or proximity sensors, selectively control the advance of the shape moulds under the filling head and/or the operation of the filling head so that the filling head can only operate when the shape mould cavities are accurately aligned with their respective injectors.

16. The shape mould plate of claim 8, wherein:
the mould cavities are configured to produce sharp edges on the resultant chocolates for improved aesthetic appearance or when preferred by the customers;
the mould cavities being machined to a profile of any size and/or shape.
